(19) United States
(12) Patent Application Publication
(10) Pub. No.: US 2012/0024896 A1
(43) Pub. Date: Feb. 2, 2012

(54) BEVERAGE CONTAINMENT AND THERMAL MANAGEMENT

(76) Inventors: Tad N. Scobey, Atlanta, GA (US); Angela R. Stegmayer, Atlanta, GA (US); Alan N. Stegmayer, Atlanta, GA (US)

(21) Appl. No.: 13/195,735

(22) Filed: Aug. 1, 2011

Related U.S. Application Data
(60) Provisional application No. 61/369,372, filed on Jul. 30, 2010.

(51) Int. Cl. B67D 7/84

(52) U.S. Cl. 222/105; 222/183

(57) ABSTRACT

Concepts and technologies are described herein for beverage containment and thermal maintenance. Functionality can be provided for configuring a cooler to support insertion and containment of a bladder for containing a liquid such as a beverage. The cooler may be used to maintain desired thermal characteristics of the liquid. A tap on the bladder may extend to the outside of the cooler through an adjustable tap port within a wall of the cooler. An opening within the port may be adjustable in size and shape to support the insertion and securing of various sized taps. A reusable bladder may be refilled and the bladder membrane may be replaced while reusing the tap mechanism. Removing the tap may also support inserting a commercially filled second bladder into the bladder while allowing the second bladder's tap to extend through the tap hole within the first bladder.

### CROSS-REFERENCE TO RELATED APPLICATION

This application claims the benefit of U.S. provisional patent application No. 61/369,372, filed on Jul. 30, 2010, entitled “Beverage Containment and Thermal Management,” which is expressly incorporated herein by reference in its entirety.

### BACKGROUND

Consumers, vendors, and the environment will benefit from increased opportunity to transport, sell, and use beverages distributed in flexible bladders. Such beverage bladders are found in increasingly available boxed wines. These wines have a significantly reduced impact on the environment and energy consumption of the production and processing of glass bottles for wine. Furthermore, the plastic bladders may be used in environments where glass may be undesirable such as at the beach, poolside, or on a boat. Flexible beverage bladders sold within cardboard boxes are cumbersome to carry and difficult to keep cold away from a large refrigerator as they generally do not fit easy into existing coolers.

It is with respect to these and other considerations that the disclosure made herein is presented.

### SUMMARY

Concepts and technologies are described herein for beverage containment and thermal maintenance. Through an implementation of the concepts and technologies presented herein, functionality can be provided for configuring a cooler to support insertion and containment of a bladder for containing a liquid such as a beverage. The cooler may be used to maintain desired thermal characteristics of the liquid, such as keeping a cold beverage cold, or keeping a warm beverage warm. The bladder may include a tap for controllably dispensing the liquid within the bladder. The cooler can include an adjustable tap port. The port can have an opening to allow the tap of the bladder to extend to the outside of the cooler. The port may be adjustable in the size and shape of the opening to support the insertion and securing of various sized taps.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view illustrating aspects of a liquid cooler with an adjustable tap port according to various embodiments presented herein;

FIG. 2 is a side view illustrating aspects of a liquid bladder inside a liquid cooler according to various embodiments presented herein;

FIG. 3 is an exploded view illustrating aspects of a reusable tap associated with a liquid bladder according to various embodiments presented herein;

FIG. 4 is a cross-sectional view illustrating aspects of an outer wall of the cooler according to various embodiments presented herein;

FIG. 5 is a perspective view illustrating aspects of a liquid cooler having a key and pocket style adjustable tap port according to various embodiments presented herein;

FIG. 6 is a detailed view illustrating aspects of a key and pocket style adjustable tap port according to various embodiments presented herein;

FIG. 7 is a perspective view illustrating aspects of a liquid cooler having a retaining flap style adjustable tap port according to various embodiments presented herein;

FIG. 8 is a detail view illustrating aspects of a tapered opening associated with a retaining flap style adjustable tap port according to various embodiments presented herein;

FIG. 9 is a detail view illustrating aspects of a retaining flap associated with a retaining flap style adjustable tap port according to various embodiments presented herein;

FIG. 10 is a perspective view illustrating aspects of a liquid cooler with an elastic membrane style adjustable tap port according to various embodiments presented herein;

FIG. 11 is a side view illustrating aspects of a refillable liquid bladder according to various embodiments presented herein;

FIG. 12 is a flattened view illustrating aspects of a liquid bladder according to various embodiments presented herein;

FIG. 13 is a side view illustrating aspects of a two chamber liquid bladder according to various embodiments presented herein;

FIG. 14 is a side view illustrating aspects of a two chamber liquid bladder according to various embodiments presented herein; and

FIG. 15 is a flattened view illustrating aspects of a two chambered liquid bladder according to various embodiments presented herein.

### DETAILED DESCRIPTION

The following description is directed to technologies for containing beverages and maintaining thermal conditions. According to various aspects of the technology presented herein, a cooler may be configured to support insertion and containment of a bladder where the bladder may be configured to containing a liquid such as a beverage. The bladder may include a tap for controllably dispensing the liquid within the bladder. The cooler can include an adjustable tap port with an opening to allow the tap of the bladder to extend to the outside of the cooler. The port may be adjustable in a size and a shape of the opening to support the insertion and securing of various sized taps.

According to various additional aspects of the technology presented herein, a bladder may be made reusable by having a fill port through which the bladder may be refilled. The bladder may have a removable tap to allow for replacement of the bladder membrane while reusing the tap mechanism. The removable tap may also support inserting a second bladder such as a commercially filled bladder into the bladder while allowing the second bladder's tap to extend through the tap hole within the first bladder. Such an arrangement can provide a void between the first and second bladder for a thermal management material such as ice, cold water, warm water, or otherwise. Similarly a two chambered bladder may be provided wherein the one chamber contains a thermal material and another contains a beverage and is associated with the tap or tap hole.

It should be appreciated that the subject matter described herein may be implemented as one or more methods, one or more apparatus, systems, or as articles of manufacture. These and various other features will be apparent from a reading of the following Detailed Description and a review of the associated drawings. In the following detailed description, references are made to the accompanying drawings that form a part hereof, and which are shown by way of illustration specific embodiments or examples. Referring now to the drawings, in which like numerals represent like elements through the several figures, aspects of a system and methodology for containing beverages and maintaining thermal conditions are presented.

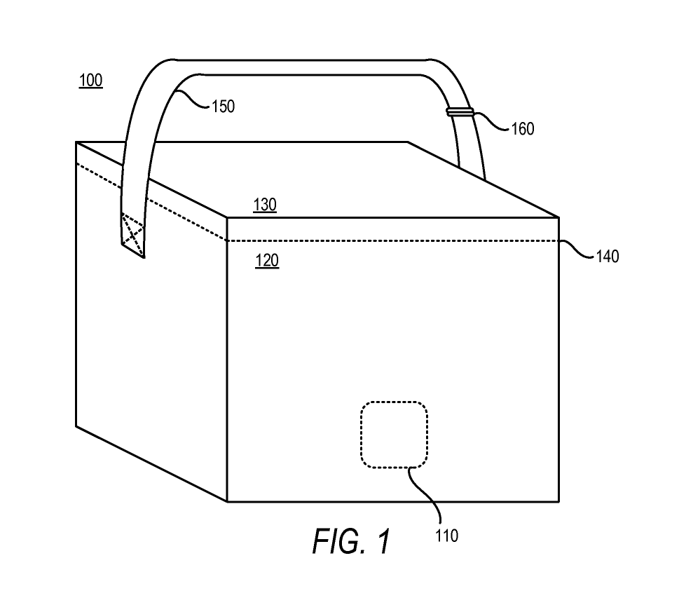

Referring now to FIG. 1, a perspective drawing illustrates a liquid cooler 100 with an adjustable tap port 110 according to one or more embodiments of the technology presented herein. A flexible bladder for containing a liquid may be placed into the liquid cooler 100. The liquid may be a beverage and the cooler 100 may be used to maintain desired thermal characteristics of the liquid. For example, a cool beverage such as wine, beer, soda, juice, water, milk, and so forth may be kept cool. Also, a warm beverage such as coffee, tea, chai, cocoa, broth, and so forth may be kept warm. The bladder may include a tap for controllably dispensing the liquid within the bladder.

The adjustable tap port 110 provides an opening to allow the tap of the bladder to protrude through. The adjustable tap port 110 can also mechanically interface with the tap, or a collar associated with the tap, to hold the tap in place within the opening. The adjustable tap port 110 may be adjusted to support taps having various geometries such that various different types of bladders may be used within the cooler 100. These various geometries may include different sizes, different shapes, or different styles of taps or tap collars. While various adjustable tap port 110 embodiments are detailed herein (such as the key and pocket style adjustable tap port 110A, the retaining flap style adjustable tap port 110B, and the elastic membrane style adjustable tap port 110C), it should be appreciated that various other adjustable tap port 110 embodiments may support an adjustable cooler opening for interfacing with variously sized liquid bladder taps without departing from the spirit or scope of the technology disclosed herein.

The cooler 100 may comprise a main body 120 and a lid 130 connected by a closure mechanism 140. The closure mechanism 140 may be as a zipper, hook-and-loop (e.g. VELCRO), button, snap, zipper lock (e.g. ZIPLOC), gasket seal, or any other type of closure. The cooler 100 may also comprise a strap 150 for carrying the cooler 100. The strap 150 may include an adjustment 160 for changing the length of the strap 150.

The main body 120 and lid 130 of the cooler 100 may be soft or rigid and may be constructed of the same materials. These materials may contain a thermally insulating layer or have a thermally insulating structure as discussed below. The strap 150 may be constructed of the same material as the main body 120. Alternatively, the strap 150 may be constructed of various other materials coordinating, or contrasting, with the main body 120.

Example materials for the cooler 100 and the main body 120 may include fabrics, woven materials, polymer materials, nylon, polyester, canvas, vinyl, neoprene, plastic, rubber, other materials formable into a sheet, or any combination thereof. The cooler 100 may have internal dimensions of an approximate cube, a rectangular prism, a cylinder, a cone, a quasi-pyramid, a tetrahedron, or any other appropriate shape for holding a beverage bladder. The interior volume may be any size, but some example embodiments may have internal dimensions from about 10 by 10 by 10 centimeters up to 20 by 20 by 20 centimeters.

A plug for filling in the tap port 110 may be provided for placement within the tap port 110 when not in use. The plug may have a geometry and structure similar to that of a tap collar for supporting engagement between the plug and tap port 110 in a similar fashion as the tap port 110 may engage with the collar of a tap.

It should be appreciated that the tap port 110 may be positioned within the wall of any cooler, box, refrigerator, cabinet or any other structure for storing, deploying, or transporting a liquid bladder. Furthermore, two or more tap ports 110 may be positioned within the cooler 100 or any other cooler, box, refrigerator, cabinet or other structure to support two or more bladders within the structure. A shelf, rack, strap, basket, sling, or other support mechanism may be positioned adjacent to, or just below, each tap port 110 to hold a respective bladder adjacent to the tap port 110 where the tap port 110 may engage with a collar associated with a tap of the bladder.

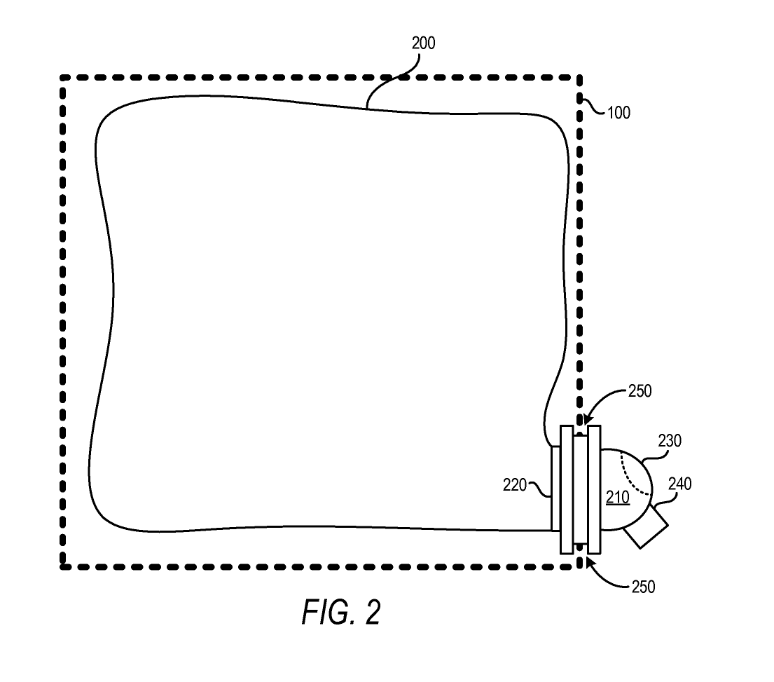

Referring now to FIG. 2, a side view diagram illustrates a liquid bladder 200 inside a liquid cooler 100 according to one or more embodiments of the technology presented herein. The bladder 200 may be referred to as a flexible bladder. The bladder 200 can hold a liquid such as a beverage. The liquid cooler 100 can enclose the bladder 200.

The bladder 200 can dispense the liquid through a tap 210. The tap 210 can attach to the bladder 200 at an inner flange 220. The attachment at the inner flange 220 may be made by adhesive, weld, threaded fitting, compression fitting, or any other mechanism for attaching the tap 210 to the bladder 200. The tap 210 may include a control 230, such as a push button, knob, lever, valve, or other control, for allowing the liquid to be dispensed through an outlet 240 within the tap 210. The tap 210 may also include a collar 250. The collar 250 can provide a mechanical interface for locking the tap 210 into an opening through an outer wall of the cooler 100.

As discussed with respect to FIG. 1, the cooler 100 may have an adjustable tap port 110. The adjustable tap port 110 can provide an opening for protruding the tap 210 through to the outside of the cooler 100. The adjustable tap port 110 can also adjustably interface with collar 250. The adjustability of the adjustable tap port 110 can support latching into the collar 250 to hold it into place while also accommodating various sizes of collars 250. The accommodation of multiple sizes and shapes of collars 250 can support the use of the cooler 100 with various commercially available bladders 200 and associated taps 210. For example, various sized taps 210 with various sized collars 250 may be present in the variety of bladder within a box wines that may be found in the marketplace.

According to various embodiments, a reusable bladder 200 may be provided with a fill port through which the bladder may be refilled. The bladder 200 may also have a removable tap 210 to allow for replacement of the bladder membrane while reusing the tap 210. The removable tap 210 may also support inserting a second bladder such as a commercially filled bladder into the bladder 200 while allowing the second bladder's tap 210 to extend through the tap hole within the first bladder 200. Such an arrangement can provide a void between the first and second bladder for a thermal management material such as ice, cold water, warm water, otherwise, or any combination thereof. Similarly, a two chambered bladder 200 may be provided wherein the one chamber (not opening into the tap 210) may be used for a thermal material and another chamber (that does open into the tap 210) may be used to contain a beverage. Some aspects of these various embodiments of the bladder 200 are discussed in further detail below.

It should be appreciated that the chamber (or multiple chambers) of the reusable bladder 200 may be opened and resealed using a screw cap, snap on cap, pressure fit seal, zipper locking seal, any other resealing mechanism, or any combination thereof. Additionally, the openings may be configured to be sealed, but not resealed, in the case of a single-use embodiment. It should also be appreciated that various types of taps 210 may be associated with various embodiments of the bladder 200 and these taps may be removable or fixed, actuated in various ways, disposable or reusable, have various sizes and shapes, and may be formed of any type of appropriate materials.

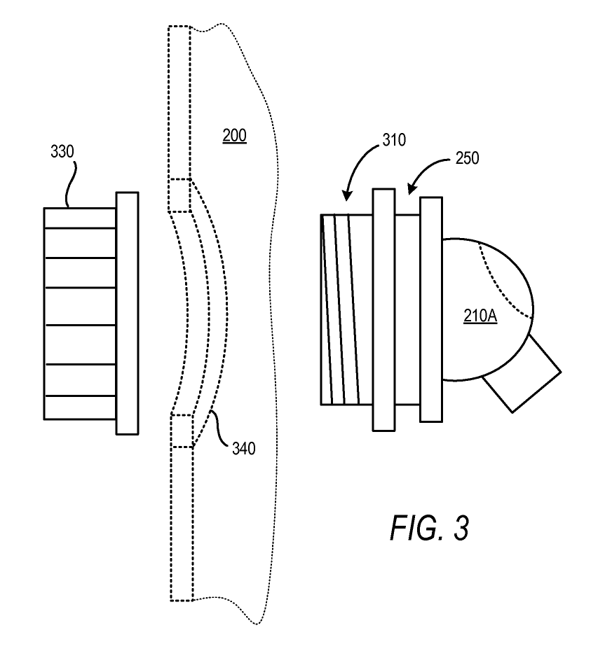

Referring now to FIG. 3, an exploded view diagram illustrates a reusable tap 210A associated with a liquid bladder 200 according to one or more embodiments of the technology presented herein. Threads 310 on the tap 210A can interface with threads on the inside of a threaded ring 330. The threaded ring 330 can be rotated onto the threads 310 of the tap 210A to secure the tap 210A into the opening in the bladder and also to seal the tap 210A into the bladder 200 to prevent a beverage contained within the bladder 200 from leaking out of the bladder 200. According to other embodiments, the removable tap 210A may be coupled to the bladder 200 using a snap-on ring, compression fitting, or any other type of coupling mechanism in place of the threads 310 and the threaded ring 330.

The bladder 200 may be formed as a bag. The bladder 200 may comprise plastics, polymeric materials, rubber, aluminum foil, any other foil, any other waterproof materials, or any combination thereof. A reinforced ring 340 may be provided around the tap opening in the bladder 200. The reinforced ring 340 of the bladder can serve as a gasket once sealed between the tap 210A and the threaded ring 330. In other embodiments where the tap 210 is not removable, the reinforced ring 340 may aid in, or be formed by, adhering or welding the tap 210 to the bladder 200.

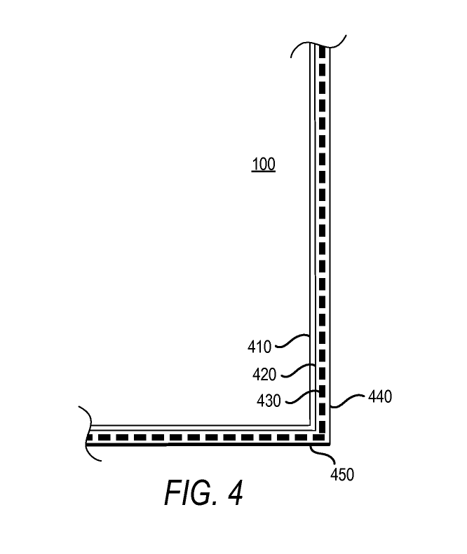

Referring now to FIG. 4, a cross-sectional view diagram illustrates an outer wall of the cooler 100 according to one or more embodiments of the technology presented herein. A liner layer 410 may be provided within the walls of the cooler 100. The liner layer 410 may be the inner-most layer within the cooler wall. The liner layer 410 may include a plastic liner. The liner layer 410 may comprise material of plastic, rubber, any polymeric material, or any combination thereof.

A waterproof layer 420 may be provided within the walls of the cooler 100. The waterproof layer 420 may be positioned just under the inner surface from the liner layer 410. The waterproof layer 420 may comprise material of plastic, rubber, any polymeric material, or any combination thereof.

An insulating layer 430 may be provided within the walls of the cooler 100. The insulating layer 430 may comprise materials of foam, polystyrene, down, felt, batting, fiber, air gap, bubble sheet, cotton, any other insulator, or any combination thereof.

An outer layer 440 may be provided on the outside of the walls of the cooler 100. The outer layer 440 may be a fabric, plastic, rubber, nylon, polymeric, cotton, polyester, any other materials, or any combination thereof. The outer layer 440 may be colored, patterned, printed, stitched, tufted, or otherwise adorned to provide a decorative, outer aesthetic to the cooler 100. This decoration may also include commercial marking, labeling, advertising, or promotional information. These markings or information may be associated with a beverage to be contained within the cooler 100.

A bottom layer 450 may be provided on the bottom surface or lower regions of the cooler. The bottom layer 450 may be the same as, or similar to, the outer layer 440. The bottom layer 450 may also be a doubled up, or otherwise reinforced, version of the outer layer 440. The bottom layer 450 may also be a hardened or reinforced material differing from the outer layer 440.

The sides of the cooler 100 may be stitched or welded through all of the layers 410-450 to form the cooler. These stitches, welds, or other affixing mechanisms may be placed along the edges, corners, or closure mechanism 140 of the cooler 100.

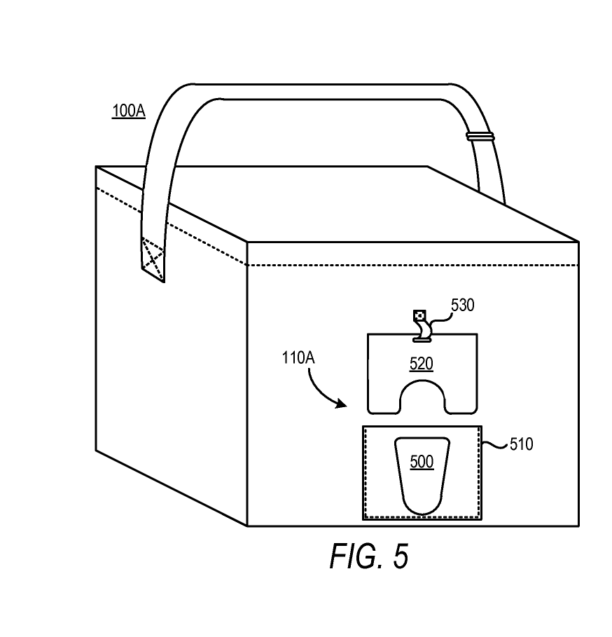

Referring now to FIG. 5, a perspective view diagram illustrates a liquid cooler 100A have a key and pocket style adjustable tap port 110A according to one or more embodiments of the technology presented herein. The adjustable tap port 110A can adjust to fit around various sized bladder taps 210. The adjustable tap port 110A can engage into a collar 250 of the tap 210 placed within the tap port 110A. A shaped key 520 slidably placed into a pocket 510 may establish the resizing and engagement of the tap port 110A. A tapered opening 500 may be provided in a wall of the cooler 100A for supporting the tap 210. The geometry of the tapered opening 500 can accommodate various sizes of tap collars 250. Sliding the shaped key 520 within the pocket 510 can adjust the size of an opening formed from the top by the key 520 and from the bottom by the tapered opening 500 within the cooler 100A. A small strap 530, or similar structure, may be affixed to the key 520 to keep the key 520 attached to the cooler 100A

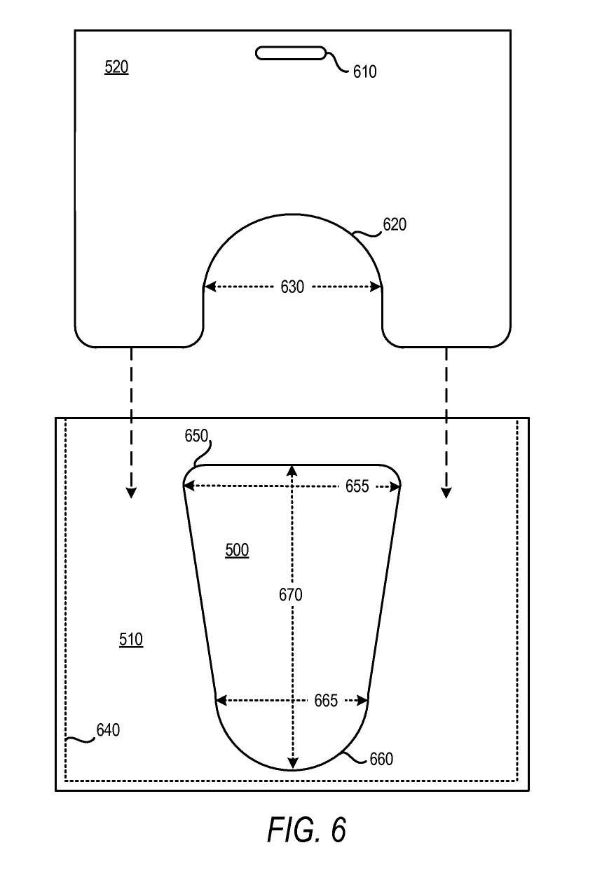

Referring now to FIG. 6, a detailed view illustrates a key and pocket style adjustable tap port 110A according to one or more embodiments of the technology presented herein. The key 520 can comprise plastic, metal, polymeric, any other rigid, or any other semi-rigid materials. A tap hole 610 may be provided at, or near, the top of the key 520 for affixing the strap 530 to the key 520. The strap 530 may flexibly couple the key 520 to the cooler 100A.

A notch 620 in the bottom of the key 520 may be provided to form an upper portion of the adjustable tap port 110A. A top portion of the notch 620 may formed of a half circle of diameter 630 or any similar shape configured to lock into the top of a collar 250 from a bladder tap 210. The diameter 630 may measure in a range from approximately 20 to 50 millimeters. It should be appreciated that other sizes may be used for the diameter 630.

The pocket 510 may comprise the same, or similar, material as the cooler 100A. The pocket 510 may be attached to the cooler 100A along edges 640 by stitching, welding, adhesive, or other fixing mechanisms.

The tapered opening 500 may be provided through a wall of the cooler 100A to support protrusion of the tap 210. The tapered opening 500 may be formed from a wider top region 650 having a top opening width 655 tapering down to a narrower bottom region 660 having a bottom opening width 665. The top opening width 655 may measure in a range from approximately 30 to 55 millimeters. The bottom opening width 665 may measure in a range from approximately 25 to 40 millimeters. It should be appreciated that any other measurements may be used for either the bottom opening width 665 or the top opening width 655 according to various other embodiments. The tapered opening 500 may have an opening height 670. The opening height 670 may measure in a range from 40 to 90 millimeters. It should be appreciated that any other measurements may be used for the opening height 670.

The key 520 may be inserted down into the pocket 510 to adjust the size of the opening so as to engage into the collar 250 portion of a tap 210 inserted into the tapered opening 500. The pocket 510 should be deep enough to allow the opening to close down to approximately 20 millimeters. It should be appreciated that the range of sizes of the opening may be different to accommodate appropriate collars 250 on various possible bladder taps 210. The bottom of the tapered opening 500 and thus the opening for the tap 210 may be approximately 10 to 40 millimeters from the bottom of the cooler 110A. As discussed above, other measurements may be used according to various embodiments.

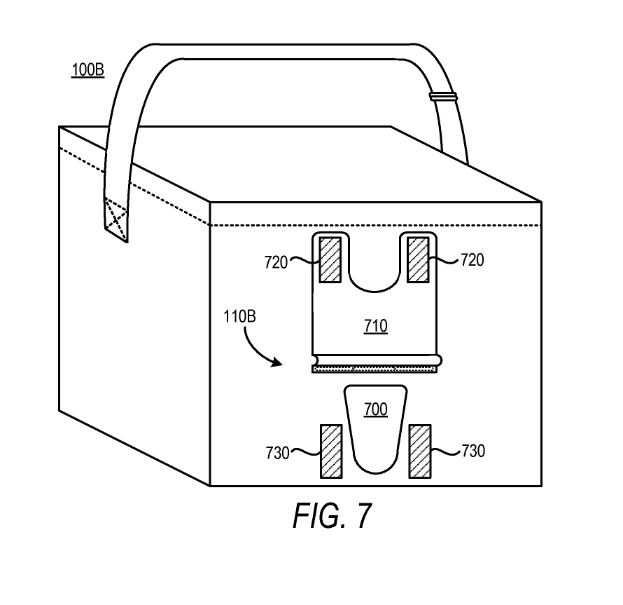

Referring now to FIG. 7, a perspective view diagram illustrates a liquid cooler 100B have a retaining flap style adjustable tap port 110B according to one or more embodiments of the technology presented herein. The cooler 100B can have a tapered opening 700 to support protrusion of the bladder tap 210 through a side wall of the cooler 100B. A retaining flap 710 may be provided above the tapered opening 700. The retaining flap 710 can rotate, or fold, downward partially over the tapered opening 700 to form an adjustable opening engaging with a collar 250 of a bladder tap 210. The retaining flap 710 may be variably and removably affixed to the body of the cooler 100B using attachment elements 720 on the flap along with mating attachment elements 730 on the cooler 100B. The attachment elements 720-730 may comprise hook-and-loop (e.g. VELCRO), button, snap, or other such attachment mechanisms. The retaining flap 710 may be constructed of rigid or semi-rigid material.

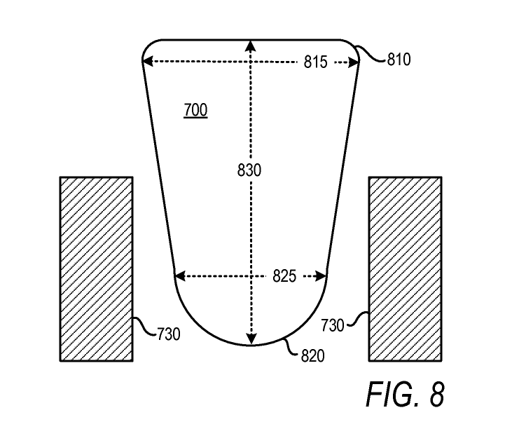

Referring now to FIG. 8, a detail view diagram illustrates a tapered opening 700 associated with a retaining flap style adjustable tap port 110B according to one or more embodiments of the technology presented herein. The tapered opening 700 may be formed from a wider top region 810 having an opening width 815 tapering down to a narrower bottom region 820 having an opening width 825. The top opening width 815 may measure in a range from approximately 30 to 55 millimeters. The bottom opening width 825 may measure in a range from approximately 25 to 40 millimeters. It should be appreciated that any other measurements may be used for either the bottom opening width 825 or the top opening width 815 according to various other embodiments. The tapered opening 700 may have an opening height 830. The opening height 830 may measure in a range from 40 to 90 millimeters. It should be appreciated that any other measurements may be used for the opening height 830. The bottom of the tapered opening 700 and thus the opening for the tap 210 may be approximately 10 to 40 millimeters from the bottom of the cooler 110B. As discussed above, other measurements may be used according to various embodiments.

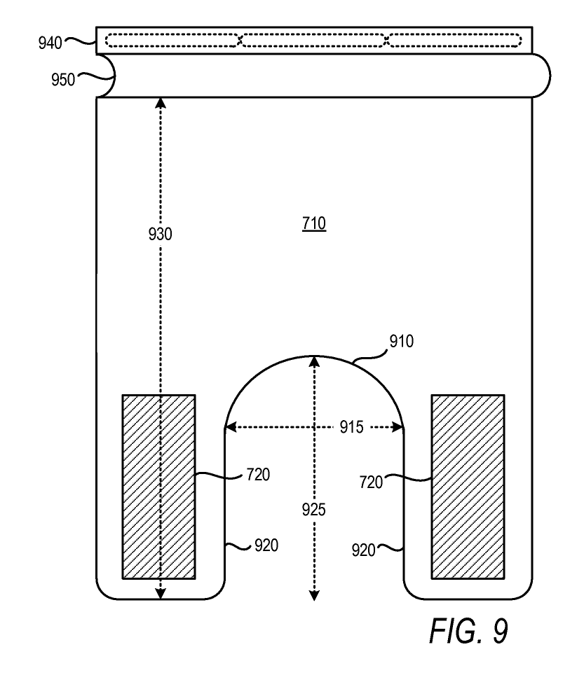

Referring now to FIG. 9, a detail view diagram illustrates a retaining flap 710 associated with a retaining flap style adjustable tap port 110B according to one or more embodiments of the technology presented herein. An affixed portion 940 of the retaining flap 710 may be attached to the cooler 100B to provide a pivot for turning or folding down the retaining flap 710. The affixed portion 940 of the retaining flap 710 may be attached to the cooler 100B using stitching, welds, adhesive, any other fixing mechanism, or any combination thereof. A flex portion 950 of the retaining flap 710 can provide extra fabric for adjusting the vertical position of the retaining flap 710 to accommodate different sizes of bladder tap collars 250. The flex portion 950 of the retaining flap 710 may measure approximately 5 to 20 millimeters. As noted, any other measurements may also be used according to various embodiments.

The portion of the retaining flap 710 beyond the flex portion 950 can have a height 930. The height 930 may be measures at 60 to 100 millimeters in length. Other measurements may be used according to various embodiments.

A notch 910 in the retaining flap 710 can adjustably combine with the tapered opening 700 to engage within the collar 250 of a bladder tap 210. The notch 910 may have an upper region that is approximately a semicircle with a diameter 915. The diameter 915 may measure in the range of 25 to 45 millimeters, or any other measurement according to various embodiments. Side legs 920 of the retaining flap 710 may extend from the semicircle of the notch 910 to form a total notch height 925. The height 925 may measure in the range of approximately 45 to 65 millimeters, or any other measurement according to various embodiments. The attachment elements 720 may be positioned upon, or substantially upon the legs 920 of the retaining flap 710.

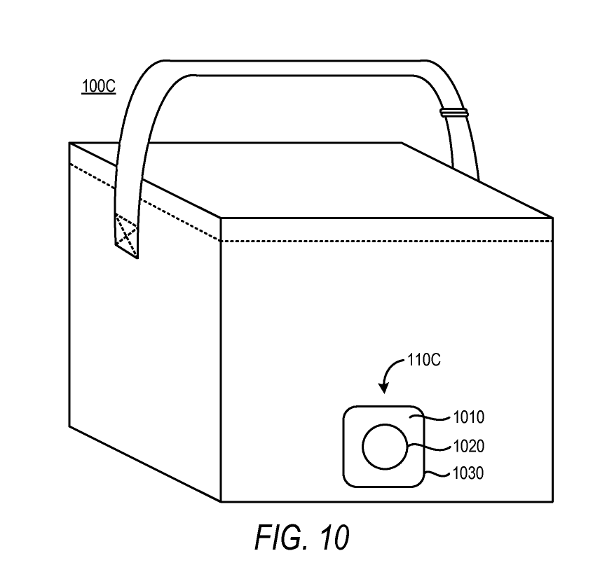

Referring now to FIG. 10, a perspective view diagram illustrates a liquid cooler 110C with an elastic membrane style adjustable tap port 110C according to one or more embodiments of the technology presented herein. An adjustable tap port 110C may also be provided by positioning an elastic membrane 1010 within an opening in the cooler 100C. A tap opening 1020 may be provided within the elastic membrane 1010. The tap opening 1020 may have a diameter measured in the range of 25 to 50 millimeters. The tap opening 1020 can adjust to various sizes of taps 210 by deforming the elastic membrane 1010. The tap opening 1020 can engage with the collar 250 of the tap 210 inserted through the adjustable tap port 110C. The tap opening 1020 may close, according to its elastic properties, to seal around the collar 250. The elastic membrane 1010 may comprise rubber, elastomeric materials, a polymer, any other elastic material, or any combination thereof.

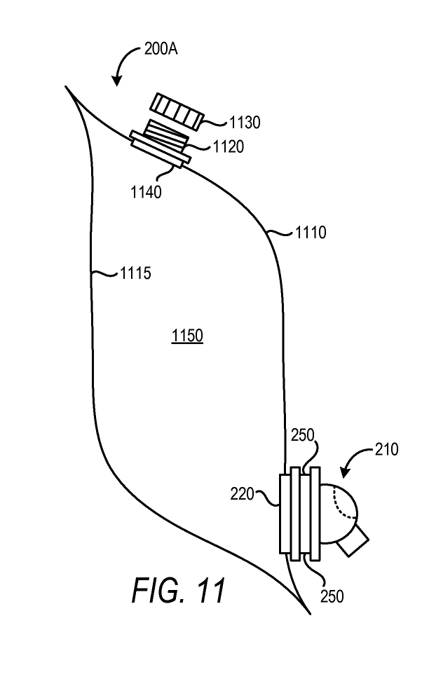

Referring now to FIG. 11, a side view diagram illustrates a refillable liquid bladder 200A according to one or more embodiments of the technology presented herein. The refillable bladder 200A may be formed from a single bag or from a front membrane 1110 and a rear membrane 1115. The interior of the refillable bladder 200A may form a void or chamber 1150 between the membranes 1110 and 1115. A fill port 1120 may be provided within the bladder 200A. The fill port 1120 may provide an opening into the chamber 1150. The fill port 1120 may be threaded to couple with a cap 1130. The fill port 1120 and cap 1130 may use some other form of closure such as a snap cap, pressure seal cap, friction sealed cap, cork plug, or so forth.

The fill port 1120 can attach to the bladder 200A at an inner flange 1140. The attachment at the inner flange 1140 may be made by adhesive, weld, threaded fitting, compression fitting, or any other mechanism for attaching the fill port 1120 to the bladder 200A.

The bladder 200A can dispense the liquid through a tap 210. The tap 210 can attach to the bladder 200A at an inner flange 220. The attachment at the inner flange 220 may be made by adhesive, weld, threaded fitting, compression fitting, or any other mechanism for attaching the tap 210 to the bladder 200A. The tap 210 may include a collar 250. The collar 250 can provide a mechanical interface for locking the tap 210 into an opening through an outer wall of the cooler 100.

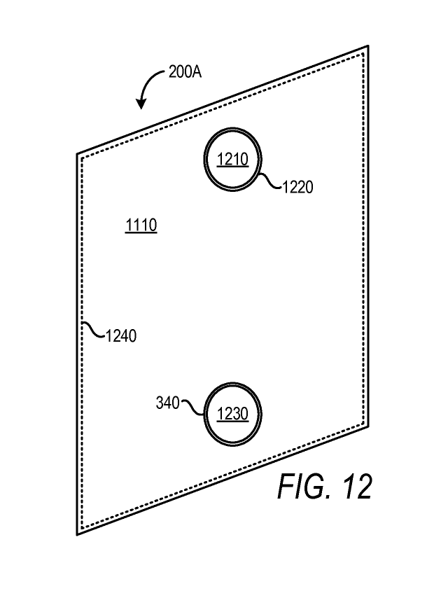

Referring now to FIG. 12, a flattened view diagram illustrates a liquid bladder 200A according to one or more embodiments of the technology presented herein. The bladder 200A may include a front membrane 1110 attached to a rear memorable 1115 at seams 1240 The seams 1240 may be welds, adhesive lines, or areas for any other type of seals. A fill port opening 1210 may be provided for attaching the fill port 1120. A fill port reinforcement 1220 may be provided as a reinforced or attachment area for affixing the fill port 1120 to the bladder 200A. A tap opening 1230 may be provided for attaching the tap 210. A tap opening reinforcement 340 may be provided as a reinforced or attachment area for affixing the tap 210 to the bladder 200A.

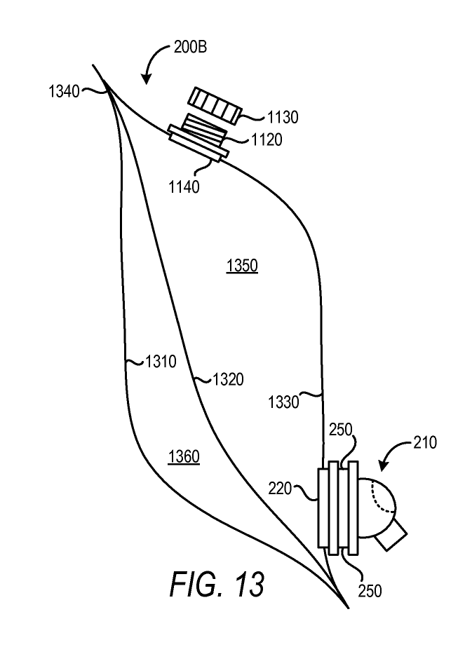

Referring now to FIG. 13, a side view diagram illustrates a two chamber bladder 200B according to one or more embodiments of the technology presented herein. The two chamber bladder 200B may be formed from a front membrane 1330, a center membrane 1320, and a rear membrane 1310. Where a front chamber 1350 is formed between the front membrane 1330 and the center membrane 1320 and a rear chamber 1360 is formed between the center membrane 1320 and the rear membrane 1310.

A fill port 1120 may be provided within the bladder 200B. The fill port 1120 may provide an opening into the front chamber 1350. The front chamber 1350 may be thus filled with a liquid such as a beverage. The fill port 1120 may be threaded to couple with a cap 1130. The fill port 1120 and cap 1130 may use some other form of closure such as a snap cap, pressure seal cap, friction sealed cap, cork plug, or so forth. The fill port 1120 can attach to the bladder 200B at an inner flange 1140.

The bladder 200B can dispense the liquid through a tap 210. The tap 210 may be a removable tap 210A such as the one described with respect to FIG. 3 or the tap 210 may be fixed. A fixed tap 210 can attach to the bladder 200B at an inner flange 220. The attachment at the inner flange 220 may be made by adhesive, weld, threaded fitting, compression fitting, or any other mechanism for attaching the tap 210 to the bladder 200B. The tap 210 may include a collar 250. The collar 250 can provide a mechanical interface for locking the tap 210 into an opening through an outer wall of the cooler 100.

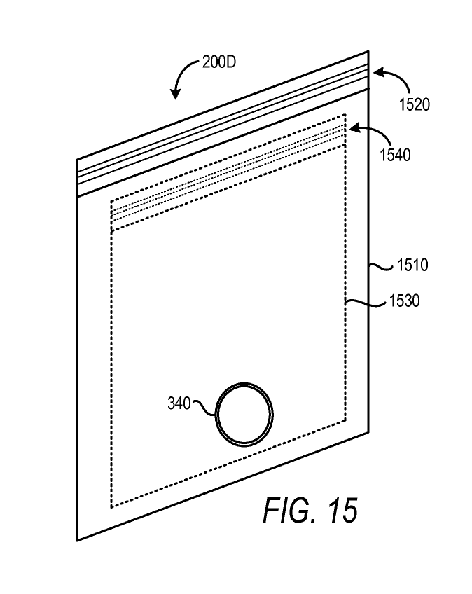

A zipper locking opening 1340 may be provided at the top edge of the bladder 200B for access the rear chamber 1360. Such a large opening may be useful for placing ice into the rear chamber 1360 as a thermal material. The zipper locking mechanism 1340 may be formed by providing opposite sides of the opening with cooperating structural features that can be coupled together or interlocked along the edge of the closure by squeezing them together. An example zipper locking mechanism 1340 is further illustrated with respect to FIG. 15. The rear chamber 1360 of the bladder 200B can contain a thermal material such as ice, water, freeze packs, hot/cold pack gel, and so forth. The thermal material may be used to warm or cool the liquid (such as a beverage) contained in the front chamber 1350.

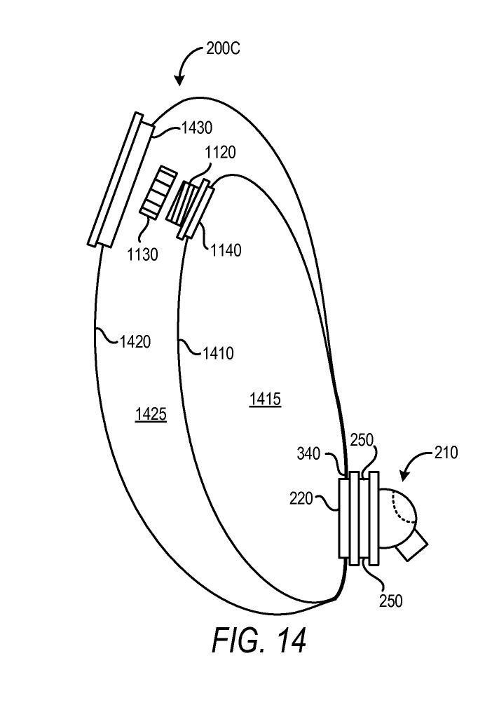

Referring now to FIG. 14, a side view diagram illustrates a two chamber bladder 200C according to one or more embodiments of the technology presented herein. The two chamber bladder 200C may include an inner membrane 1410 forming an inner chamber 1415 and an outer membrane 1420 forming an outer chamber 1425.

A fill port 1120 may be provided within the bladder 200C. The fill port 1120 may provide an opening into the inner chamber 1415. The inner chamber 1415 may be thus filled with a liquid such as a beverage. The fill port 1120 may be threaded to couple with a cap 1130. The fill port 1120 and cap 1130 may use some other form of closure such as a snap cap, pressure seal cap, friction sealed cap, cork plug, or so forth. The fill port 1120 can attach to the bladder 200C at an inner flange 1140.

The bladder 200C can dispense the liquid through a tap 210. The tap 210 can attach to the bladder 200C at an inner flange 220. The attachment at the inner flange 220 may be made by adhesive, weld, threaded fitting, compression fitting, or any other mechanism for attaching the tap 210 to the tap attachment area 340 of the bladder 200C. The tap 210 may include a collar 250. The collar 250 can provide a mechanical interface for locking the tap 210 into an opening through an outer wall of the cooler 100.

An outer cap 1430 may be provided for accessing the outer chamber 1425. The outer cap 1430 may be screw-on, snap-on, pressure fit, or any other closure mechanism. The outer cap 1430 may be large enough to allow ice (or other thermal material as discussed above) to be filled into the outer chamber 1425. The outer cap 1430 may also be large enough to support accessing the inner cap 1130 through the outer cap 1430.

Referring now to FIG. 15, a flattened view diagram illustrates a two chambered bladder 200D according to one or more embodiments of the technology presented herein. The two chambered bladder 200D can include an inner chamber 1530 and an outer chamber 1510. The inner chamber 1530 can provide an inner zipper locking closure 1540 to access the interior of the inner chamber 1530. The inner chamber 1530 may contain a liquid such as a beverage along with a dispensing tap 210. A reinforced tap opening 340 may support the attachment of a removable tap 210A such as the one described with respect to FIG. 3. The reinforced tap opening 340 may support a fixed, or non-removable, tap 210.

Alternatively, the inner chamber 1530 may support an entire commercially available beverage bladder. The tap 210 of such a commercial bladder may protrude from the bladder 200D through the reinforced tap opening 340. The outer chamber 1510 may support an outer zipper locking closure 1520 for filling with ice or other thermal material.

Based on the foregoing, it should be appreciated that technologies for containing beverages and maintaining thermal conditions are presented herein. Although the subject matter presented herein has been described in language specific to various example embodiments, it is to be understood that the invention disclosed herein is not necessarily limited to the specific features, materials, dimensions, or structures described herein. Rather, the specific features, materials, dimensions, and structures are disclosed as example forms of implementation.

The subject matter described above is provided by way of illustration only and should not be construed as limiting. Various modifications, combinations, and changes may be made to the subject matter described herein without following the example embodiments and applications illustrated and described, and without departing from the true spirit and scope of the present invention, which is set forth in the following claims.

What is claimed is:

1. A liquid cooler comprising:
a cooler body configured to enclose a flexible bladder containing a liquid to be dispensed;
a thermally insulating structure associated with the cooler body and configured to maintain a thermal condition of said liquid; and
a tap port within the cooler body configured to support a tap associated with said flexible bladder extending from within the cooler body to outside the cooler body, wherein the tap port is adjustable to accommodate varying tap geometries.

2. The liquid cooler of claim 1, wherein the tap port comprises a tapered opening within the cooler body.

3. The liquid cooler of claim 1, wherein the tap port comprises a shaped key configured to engage with a collar of said tap.

4. The liquid cooler of claim 1, wherein the tap port comprises a tapered opening within the cooler body and a shaped key, wherein the tapered opening and the shaped key are configured to engage a collar of said tap.

5. The liquid cooler of claim 1, wherein the tap port comprises a retaining flap configured to engage a collar of said tap.

6. The liquid cooler of claim 1, wherein the tap port comprises a tapered opening within the cooler body and a retaining flap, wherein the tapered opening and the retaining flap are configured to engage a collar of said tap.

7. The liquid cooler of claim 1, wherein the tap port comprises an elastic membrane configured to engage a collar of said tap

8. The liquid cooler of claim 1, further comprising a reusable bladder.

9. The liquid cooler of claim 8, wherein the reusable bladder is configured to contain a liquid.

10. The liquid cooler of claim 8, wherein the reusable bladder comprises a removable tap.

11. The liquid cooler of claim 10, wherein the reusable bladder is configured to enclose the flexible bladder.

12. The liquid cooler of claim 11, wherein a void formed within the reusable bladder and outside of the flexible bladder is configured to enclose a thermal management material.

13. The liquid cooler of claim 1, further comprising a dual-chambered bladder.

14. The liquid cooler of claim 13, wherein a first chamber of the dual-chambered bladder is configured to enclose a beverage and a second chamber of the dual-chambered bladder is configured to enclose a thermal management material.

15. The liquid cooler of claim 13, wherein a first chamber of the dual-chambered bladder is configured to enclose the flexible bladder and a second chamber of the dual-chambered bladder is configured to enclose a thermal management material.

16. A tap port positioned within a liquid cooler comprising:
a tapered opening configured to support a tap associated with a flexible bladder, wherein the flexible bladder is placed within the liquid cooler and the tap extends from within the liquid cooler to outside the liquid cooler for dispensing liquid from the flexible bladder; and
a shaped key, wherein the tapered opening and the shaped key are configured to engage a collar of the tap and accommodate varying geometries associated with the collar.

17. The tap port of claim 16, further comprising a strap for flexibly affixing the shaped key to the liquid cooler.

18. A liquid cooler tap port system comprising:
a tapered opening configured to support a tap associated with a flexible bladder, wherein the flexible bladder is placed within the liquid cooler and the tap extends from within the liquid cooler to outside the liquid cooler for dispensing liquid from the flexible bladder; and
a retaining flap, wherein the tapered opening and the retaining flap are configured to engage a collar of the tap and accommodate varying geometries associated with the collar.

19. The system of claim 18, wherein the liquid cooler comprises a reusable bladder.

20. The system of claim 18, wherein the liquid cooler comprises a dual-chamber reusable bladder.
